(19) United States
(12) Patent Application Publication
(10) Pub. No.: US 2019/0247799 A1
(43) Pub. Date: Aug. 15, 2019

(54) Method and System for Increasing the Thickness of a Carbon Nanotube Sheet Structure

(71) Applicants: FUNDACIÓN TECNALIA RESEARCH & INNOVATION, San Sebastian - Guipuzcoa (ES); SISTEPLANT S.L., Derio-Vizcaya (ES)

(72) Inventors: Xabier Cenigaonaindía, Derio-Vizcaya (ES); Angel Hernán, Derio-Vizcaya (ES); Sonia Florez, San Sebastian - Guipuzcoa (ES); Idoia Gaztelumendi, San Sebastian -Guipuzcoa (ES); Richard Seddon, San Sebastian -Guipuzcoa (ES); Jose Ramón García, San Sebastian - Guipuzcoa (ES); Maialen Chapartegui, San Sebastian -Guipuzcoa (ES)

(21) Appl. No.: 16/272,024

(22) Filed: Feb. 11, 2019

(30) Foreign Application Priority Data
Feb. 12, 2018 (EP) 18382078.6

(51) Int. Cl. B01D 67/00; B01D 69/10; B01D 71/02; D21H 13/50; D21F 11/00

(52) U.S. Cl. CPC B01D 67/0095; B01D 67/0083; B01D 69/10; B01D 71/021; B82Y 30/00; D21F 11/00; B01D 2323/42; B01D 2323/34; D21H 13/50

(57) ABSTRACT

A method for increasing the thickness of a sheet of CNTs (146, 147, 246, 346), comprising: providing a wet sheet of CNTs, wherein the sheet of CNTs is either a continuous sheet of CNTs or a portion of sheet of CNTs, wherein the wet sheet of CNTs is the result of applying a process for manufacturing a sheet of CNTs; separating the wet sheet of CNTs from any filter or support element; drying the wet sheet of CNTs (146, 147, 246, 346) by applying heat (15, 25, 35) from a heat source (12, 22, 32). A method for manufacturing a continuous sheet of CNTs, comprising: in a container (41) filled with a liquid solution (42) comprising CNTs at certain concentration, submerging a vacuum tank (43) having a lower surface forming a grillage; moving an elongated filtering membrane (44) along the lower surface of the vacuum tank (43) while vacuum is applied on the elongated filtering membrane (44) in such a way that in the surface of the filtering membrane (44) opposed to the surface in contact with the lower surface of the vacuum tank (43) CNTs are deposited forming a continuous sheet of CNTs (45) of constant thickness; taking the filtering membrane (44) together with the continuous sheet of CNTs (45) out of the container (41); washing the continuous sheet of CNTs (55) disposed on the filtering membrane or on a support element (54) in a second container (51) filled with cleaning solution (52); taking the continuous sheet of CNTs (55) together with the filtering membrane or the support element (54) out of the second container (51); separating the continuous sheet of CNTs (55) from the filtering membrane or the support element (54); drying the continuous sheet of CNTs (55) by applying the method for increasing the thickness of a sheet of CNTs.

### TECHNICAL FIELD

The present invention relates to the manufacturing of materials and structures. More particularly, it refers to methods and systems for manufacturing materials and structures from carbon nanotubes, also referred to as buckypaper (BP).

### STATE OF THE ART

Carbon nanotubes (CNTs) are used in the manufacturing of high performance material and devices. Processes for the continuous manufacturing of CNT-based BPs have been disclosed in the last years. Such processes typically include making a suspension of CNTs dispersed in a liquid medium and filtering the suspension by moving a filter membrane through the suspension, such that the CNTs are deposited directly on the filter membrane as the fluid medium flows through the filter membrane. The continuous BP is then dried, after which it can be separated from the filter membrane. An example of this process is disclosed in U.S. Pat. No. 7,459,121B2.

US2016/0177511A1 discloses a method for continuous manufacturing of a CNT sheet in which a porous plate flanked by two guiding rollers acts as filtration area and is disposed within a suspension chamber filled with a suspension of CNTs. A filter paper is advanced to the filtration area. When vacuum pressure is applied, CNTs are deposited on the portion of the filter paper in contact with the filtration area. The portion of the filter paper with the deposited CNTs is then advanced to a drying area. After drying, the filter paper is separated from the continuous sheet of CNTs, thus obtaining a roll of filter paper and a roll of continuous sheet of CNTs.

A similar approach is disclosed in WO2016/019143A1, in which a volume of a CNT suspension is passed over a filter material and drawn through the filter material to provide a uniform dispersion of the CNTs over the filter material. The filter material is in the form of a continuous porous belt. The filtered CNT structure is dried prior to removing the CNT sheet from the porous filter material.

However, the time required for obtaining a sheet of CNTs of a predetermined thickness with the conventional manufacturing processes is relatively high, as a consequence of which these processes are of poor efficiency. Moreover, as the thickness of the CNT sheet increases, the thickness increasing rate slows down. In other words, the thickness vs filtering time curve has a non-linear behavior, as shown for example in FIG. 6, which shows a thickness vs filtration time graph in a conventional BP continuous manufacturing pilot line. The thickness of the BP is expressed in μm (microns, 10⁻⁶ meters), while the time is expressed in minutes. As can be seen in FIG. 6, when targeting 100% of the thickness, in 30% of the nominal time, 50% of the thickness is generated. Thickness generation slows down as BP thickness increases. This effect is even greater for larger target thickness.

### DESCRIPTION OF THE INVENTION

The present disclosure provides a new method and system for increasing the thickness of a sheet of CNTs or buckypaper (BP). A buckypaper is a thin sheet made from an aggregate of carbon nanotubes or carbon nanotube grid paper. Because when manufacturing a CNT sheet, its thickness increase rate is reduced as its thickness increases, obtaining the last portion of aimed thickness (typically several microns or μm) requires more time than the previous ones. The present disclosure provides a method that enables increasing the last portion of aimed thickness in a much faster process, in such a way that the above-mentioned slowing effect is minimized and the time required for obtaining the sheet of CNTs of a desired thickness is reduced. So, the aimed thickness of BP may be obtained as follows: First, a first amount of thickness of BP may be obtained by any conventional method, and then, a second amount of thickness (the remaining amount until the desired thickness is reached) may be additionally obtained by means of the method of the present disclosure. As a matter of example, the first amount of thickness may be around 85% of the aimed thickness. This may result in a time saving of about 25% for a same aimed thickness.

The buckypaper (or sheet of CNTs) whose thickness is increased may be obtained in the form of a continuous sheet, or in the form of batch portions (single portions). In the context of the present disclosure, a continuous sheet of material is an elongated sheet having a length that is orders of magnitude greater than the width of the sheet. The continuous sheet of material may be provided in the form of a roll of the sheet material. A continuous sheet of material may be obtained by performing a continuous manufacturing process. In the context of the present disclosure, a batch portion or single portion of material is a portion having length and width of same or similar order of magnitude.

The sheet of CNTs may be circular or rectangular or of any other shape. When it is rectangular, the sheet may be continuous (for example to be provided in a roll) or non-continuous, also referred to as batch or portion (for example a portion of length and width of similar order of magnitude). The width and length of the sheets of CNTs may vary depending on the manufacturing process.

The present disclosure also provides a new method and system for drying a wet sheet of CNTs, the drying method being continuous, intermittent or static. The drying method of this disclosure optimizes the drying stage in a process of manufacturing a sheet of CNTs, the sheets being either continuous or batch. With the proposed drying method, the thickness of the sheet of CNTs is increased, and therefore the manufacturing speed is also increased.

The present disclosure also provides a new method and system for manufacturing a sheet of CNTs, in which the stage of drying the wet sheet of CNTs (either continuous or batch) is optimized.

The inventors have observed that, when manufacturing a sheet of CNTs by applying vacuum and a filter material, for example as disclosed in WO2016/019143A1, some CNTs get trapped in the pores of the mentioned filter. The inventors have also observed that, due to such trapping forces, the dimensions of the sheet of CNTs cannot change during drying. In the present disclosure, the wet sheet of CNTs is separated from any filter material. In other words, the wet sheet of CNTs is dried without filter material or support. This way the effect of the CNTs trapped in the filter material pores is eliminated, thus enabling changes in dimensions during drying, in particular increasing the thickness. This means that, when the process for increasing the thickness of a sheet of CNTs is applied during the manufacturing process of a sheet of CNTs, the wet sheet of CNTs is dried after separating the CNTs sheet from the filter material. Or, when the process for increasing the thickness of a sheet of CNTs is applied long after the manufacturing process of the sheet of CNTs, for example when the sheet of CNTs is provided/commercialized together with a support, the sheet of CNTs is separated from the support, then soaked in an aqueous solution, such as in water, and finally the drying process for increasing its thickness is applied.

The methods and systems of this disclosure enable the obtaining of sheets of CNTs, either continuous or batch, at a relatively fast rate compared to conventional setups due to the increasing in thickness achieved in the proposed drying stage.

The method for increasing the thickness of a sheet or CNTs or buckypaper of the present disclosure may be applicable to any sheet of CNTs or buckypaper obtained from any conventional manufacturing process. The areal weight of the sheet of CNTs prior to applying the drying method of the present disclosure, may be adjusted by tailoring the manufacturing conditions, such as the concentration of the CNT suspension, the applied vacuum pressure, the filtration speed, the filtration duration, the type of filter (for example of the grillage) or a combination thereof, during the manufacturing process.

The thickness of the sheets of CNTs obtained in the method of the present disclosure, that is to say, dried after separating the sheet of CNTs from any support, such as a filter support, has been observed to be substantially higher than the thickness of sheets of CNTs dried prior to separating the sheet of CNTs from the filter support, considering identical sheets of CNTs and identical drying conditions. In particular, it has been observed that the thickness of sheets of CNTs of the present disclosure (dried without any support material, that is to say, after separating the sheet of CNTs from the any support material) is up to 15% larger than the thickness of sheets of CNTs dried prior to separating the sheet of CNTs from any support. In some embodiments of the invention, it is up to 13% larger, or up to 11% larger, or up to 8% larger or up to 6% larger.

In some embodiments of the invention, the thickness of the resulting sheet of CNTs, which has been increased up to 15% with respect to drying before separation of sheet and support, varies between 40 and 100 μm (1 μm=1 micron=10⁻⁶ meters).

In order to apply the method for increasing the thickness of a sheet of CNTs, a wet sheet of CNTs is used. The wet sheet of CNTs may be obtained by applying a conventional method for manufacturing sheets of CNTs. In embodiments of the invention, it is obtained as follows: in a container filled with a liquid solution comprising CNTs at certain concentration, submerging a vacuum tank having a lower surface forming a grillage; moving an elongated filtering membrane along the lower surface of the vacuum tank while vacuum is applied on the elongated filtering membrane in such a way that in the surface of the filtering membrane opposed to the surface in contact with the lower surface of the vacuum tank CNTs are deposited forming a continuous sheet of CNTs of constant thickness; taking the filtering membrane together with the continuous sheet of CNTs out of the container; washing the continuous sheet of CNTs disposed on the filtering membrane or on a support element in a second container filled with cleaning solution; taking the continuous sheet of CNTs together with the filtering membrane or the support element (54) out of the second container. In order to apply the method of the invention, the continuous sheet of CNTs is separated from the filtering membrane or the support element. Alternatively, the wet sheet of CNTs may be obtained by soaking in an aqueous solution a dry sheet of CNTs. For example, the dry sheet of CNTs may be in the form of a roll of continuous sheet of CNTs, or a portion of sheet of CNTs, that has been manufactured by any conventional manufacturing process.

A first aspect of the invention refers to a method for increasing the thickness of a sheet of CNTs, comprising: providing a wet sheet of CNTs, wherein the sheet of CNTs is either a continuous sheet of CNTs or a portion of sheet of CNTs, wherein the wet sheet of CNTs is the result of applying a process for manufacturing a sheet of CNTs; separating the wet sheet of CNTs from any filter or support element; drying the wet sheet of CNTs by applying heat from a heat source.

In embodiments of the invention, the wet sheet of CNTs being the result of applying a process for manufacturing a sheet of CNTs, is obtained by soaking in a liquid medium a dry sheet of CNTs already manufactured.

In embodiments of the invention, the sheet of CNTs is continuous or a single portion thereof (batch portion).

In embodiments of the invention, the drying stage implies a continuous advancing of the sheet of CNTs, or an intermittent advancing thereof, or is static.

In embodiments of the invention, the sheet of CNTs is a continuous sheet of CNTs and the drying of the wet continuous sheet of CNTs is done as follows: moving forward the wet continuous sheet of CNTs in a longitudinal direction until a portion thereof is disposed within a drying unit comprising the heat source, the heat source being configured to provide heat to a drying area, the drying unit further comprising screening means for delimiting said drying area, in such a way that the portion of continuous sheet of CNTs is subject to heat only until while it is under the drying area.

The drying unit may comprise a plurality of rollers configured to rotate freely and to guide the continuous sheet of CNTs along its longitudinal direction, forcing the continuous sheet of CNTs to adopt soft convex and concave curvatures in an alternate way.

The plurality of rollers may comprise a central roller disposed under the drying area and lateral rollers disposed under the screening means.

The drying unit may comprise two conveyor belts configured to guide the continuous sheet of CNTs in its longitudinal direction, the conveyor belts being longitudinally disposed above and below the continuous sheet of CNTs, respectively.

At least one of the conveyor belts may be made of a porous material or comprises a grillage, in order to favour the entrance of heat and also to favour liquid evaporation, therefore reducing the drying time.

In embodiments of the invention, the heating source is an infrared irradiation source or a convection source or hot air source, or an ultra-violet (UV) irradiation source or an electrical resistance (ER) radiation source, or a conduction source.

Because the wet sheet of CNTs is dried without the support, such as filtering support, with which it has been manufactured, the thickness of the resulting sheet of CNTs is increased. The resulting sheet of CNTs has uniform thickness increase without causing any irregular deformations such as wrinkles and buckling.

A second aspect of the invention refers to a method for manufacturing a continuous sheet of CNTs, comprising: in a container filled with a liquid solution comprising CNTs at certain concentration, submerging a vacuum tank having a lower surface forming a grillage; moving an elongated filtering membrane along the lower surface of the vacuum tank while vacuum is applied on the elongated filtering membrane in such a way that in the surface of the filtering membrane opposed to the surface in contact with the lower surface of the vacuum tank CNTs are deposited forming a continuous sheet of CNTs of constant thickness; taking the filtering membrane together with the continuous sheet of CNTs out of the container; separating the continuous sheet of CNTs from the filtering membrane or the support element; drying the continuous sheet of CNTs by applying the method already disclosed.

Prior to separating the continuous sheet of CNTs from the filtering membrane or the support element, the method may comprise washing the continuous sheet of CNTs disposed on the filtering membrane or on a support element in a second container filled with cleaning solution; taking the continuous sheet of CNTs together with the filtering membrane or the support element out of the second container.

Thanks to the optimized drying stage, in which the sheet of CNTs is separated from the filter support with which it has been manufactured before drying the sheet of CNTs, the invention provides a sheet of CNTs with increased thickness with respect to conventional ones, considering similar conditions (filtering and optionally washing stage). The resulting sheet of CNTs has uniform thickness increase without causing any irregular deformations such as wrinkles and buckling.

A third aspect of the invention refers to a system for increasing the thickness of a sheet of CNTs, the system comprising a drying unit comprising a heat source configured to provide heat to a drying area, the drying area being configured to receive the sheet of CNTs.

In embodiments of the invention, the sheet of CNTs is continuous, the drying area being configured to receive the wet continuous sheet of CNTs as it moves forward in its longitudinal direction, the drying unit further comprising screening means for delimiting said drying area, in such a way that the portion of continuous sheet of CNTs is subject to heat only until while it is under the drying area.

In embodiments of the invention, the drying area may comprise means for preventing deformation of the continuous sheet of CNTs during the drying stage, said means being either a plurality of rollers configured to rotate freely and to guide the continuous sheet of CNTs along its longitudinal direction, forcing the continuous sheet of CNTs to adopt soft convex and concave curvatures in an alternate way, or two conveyor belts configured to guide the continuous sheet of CNTs in its longitudinal direction.

Additional advantages and features of the invention will become apparent from the detail description that follows and will be particularly pointed out in the appended claims.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1A shows a schematic representation of a first system for carrying out the method of increasing the thickness of a sheet of CNTs of the present disclosure, or for carrying out the method of drying a sheet of CNTs of the present disclosure. The shown configuration is suitable for increasing the thickness of a batch sheet of CNTs, that is to say, a portion of sheet of CNTs, in which a heat source and a drying area are shown.

FIG. 1B shows a schematic representation of a second system for carrying out the method of increasing the thickness of a sheet of CNTs of the present disclosure, or for carrying out the method of drying a sheet of CNTs of the present disclosure. The shown configuration is suitable for increasing the thickness of a continuous sheet of CNTs, in which a heat source and a drying area are shown in a direct roll to roll configuration.

FIG. 2 shows a schematic representation of a third system for carrying out the method of increasing the thickness of a sheet of CNTs of the present disclosure, or for carrying out the method of drying a sheet of CNTs of the present disclosure. The shown configuration is suitable for increasing the thickness of a continuous sheet of CNTs, in which a heat source and a drying area are shown in a configuration including CNT sheet straightening rolls.

FIG. 3 shows a schematic representation of a fourth system for carrying out the method of increasing the thickness of a sheet of CNTs of the present disclosure, or for carrying out the method of drying a sheet of CNTs of the present disclosure. The shown configuration is suitable for increasing the thickness of a continuous sheet of CNTs, in which a heat source and a drying area are shown in a configuration including double supporting belts.

FIG. 4 shows a schematic representation of a filtering stage in a conventional method for manufacturing a wet continuous sheet of CNTs.

FIG. 5 shows a schematic representation of a washing stage in a conventional method for manufacturing a wet continuous sheet of CNTs according to embodiments of the invention.

FIG. 6 shows a thickness vs filtration time graph in a conventional BP continuous manufacturing pilot line.

FIG. 7 shows the graph of FIG. 6, in which the time saving obtained when applying the method of the present disclosure is remarked.

### DESCRIPTION OF A WAY OF CARRYING OUT THE INVENTION

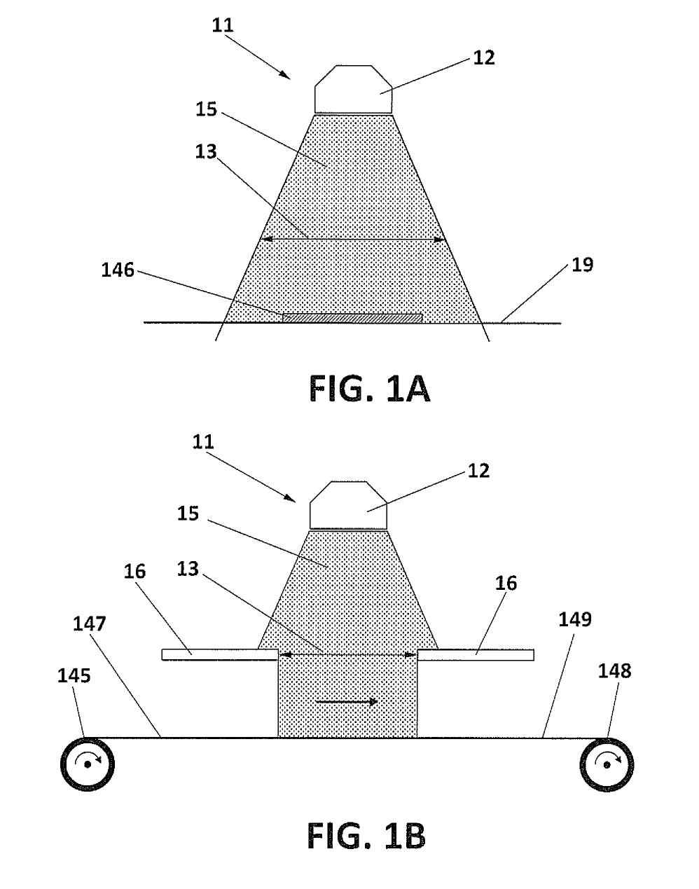

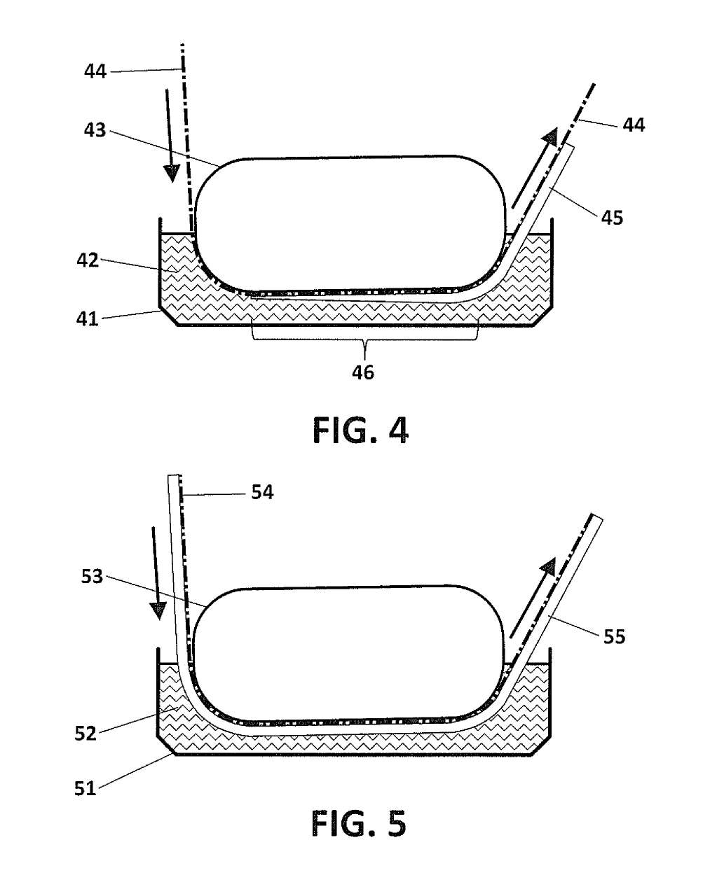

FIGS. 1A, 1B, 2 and 3 show different embodiments of systems for increasing the thickness of a sheet of CNTs, or for drying a sheet of CNTs. The sheet of CNTs that is subject to the method of the invention must be wet. The sheet of CNTs may be wet because it has left a filtering stage or a washing stage in a process for manufacturing sheets of CNTs, as described in relation with FIGS. 4 and 5. Alternatively, the sheet of CNTs may be wet because an already dry sheet of CNTs (which is dry for example because it has been manufactured well in advanced) has been soaked in an aqueous solution on purpose in order to apply the method of the invention. In embodiments of the invention, the sheet of CNTs is preferably totally wet, for example because it has just left a filtering stage such as the one shown in FIG. 4, or a washing stage such as the one shown in FIG. 5, or because it has just been totally soaked, for example submerged in an aqueous solution.

As a matter of example, but without limitation, a possible method that may be used for manufacturing a wet sheet of CNTs is disclosed in view of FIGS. 4-5. In this case, the manufactured sheet of CNTs is continuous and stored in rolls. In FIG. 4, a filtering stage is shown. In FIG. 5, an optional washing stage is shown. A similar approach may be applied, mutatis mutandis, for manufacturing batch sheets of CNTs (not continuous sheets provided for example in rolls).

FIG. 4 shows a schematic representation of a filtering stage of a process for manufacturing a wet continuous sheet of CNTs. A container 41 is filled with a liquid solution 42 comprising CNTs at certain concentration. A vacuum tank 43 is submerged in the container 41. The vacuum tank 43 has a lower surface forming a grillage. An elongated filtering membrane 44 is moved along the lower surface of the vacuum tank 43, at a certain speed, while constant vacuum is applied to the filtering membrane 44 in a constant way by means of a vacuum valve, not illustrated, in order to remove solution 42 from the container 41. This way, CNTs are deposited on the surface of the filtering membrane 44 opposed to the surface in contact with the lower surface of the vacuum tank 43, forming a continuous sheet of CNTs 45 of substantially constant thickness. The filtering membrane 44 may be provided in rolls, not illustrated, that are unrolled, typically in an automatic way, while the unrolled membrane 44 moves into the container 41. Similarly, the filtering membrane 44 with the continuous sheet of CNTs 45 deposited thereon may be rolled up while it leaves the container 41, forming a roll (not shown). In FIG. 4, the filtering area, in which the CNTs are deposited on a portion of the filtering membrane 44, is identified and referred to as 46. The speed of this stage depends on the desired thickness of the sheet of CNTs 45.

After the filtering stage of FIG. 4, the continuous sheet of CNTs may enter a washing stage, as shown in FIG. 5. In FIG. 5, the filtering membrane 54, together with the continuous sheet of CNTs 55, is moved into a second container 51 filled with cleaning solution 52. Another vacuum tank 53 is submerged in the second container 51. Constant vacuum is applied by means of a vacuum valve, in order to remove cleaning solution from the container, in such a way that the continuous sheet of CNTs 55 is washed in contact with the cleaning solution. The filtering membrane 54 with the cleaned continuous sheet of CNTs 55 continuously leaves the container 51 in a wet state. The applied vacuum pressure and the speed may be tailored in order to control the characteristics of the wet continuous sheet of CNTs 55.

Next, different embodiments of the drying stage for increasing the thickness of a sheet of CNTs according to the present invention are disclosed. The sheet of CNTs must be wet (for example, as it comes from the washing stage illustrated in FIG. 5). The wet sheet of CNTs is dried without the filter support used to manufacture that sheet of CNT or without any other kind of support. In other words, the wet sheet of CNTs is naked, that is to say, separated from the filter support (for example filtering membrane) with which it leaves a filtering stage (for example the one in FIG. 4), or separated from the support with which it leaves a washing stage (for example the one in FIG. 5), or separated from any support with which an already dry manufactured sheet of CNTs is typically commercialized. This means that, when the process for increasing the thickness of a sheet of CNTs is applied during the manufacturing process of a sheet of CNTs, the wet sheet of CNTs is dried after separating the CNT sheet from the filter support. Or, when the process for increasing the thickness of a sheet of CNTs is applied long after the manufacturing process of the sheet of CNTs, for example when the sheet of CNTs is provided together with a support, the sheet of CNTs is separated from the support, then soaked in an aqueous solution, and finally the drying process for increasing its thickness, according to the present disclosure, is applied.

For example, if the method for increasing the thickness of the sheet of CNTs is applied after the washing stage shown in FIG. 5, during a manufacturing process of sheets of CNTs, the continuous sheet of CNTs 55 is separated from the filtering material 54 prior to the drying stage. A roll (not shown) comprising the wet continuous sheet of CNTs 55 together with any support, is continuously unrolled. While it is unrolled, the sheet of CNTs is separated from any filtering or support element.

FIG. 1A shows a schematic representation of a first system for carrying out the method of the invention. The shown configuration is suitable for increasing the thickness of a batch portion of sheet of CNTs 146. A drying unit 11 is shown. The wet sheet of CNTs 146 is disposed on a surface 19 subject to the heat 15 provided by a heat source 12. The heat source 12 is configured to provide heat 15 to a drying area 13, under which or within which the sheet of CNTs 146 is placed. The heat source 12 may be movable. The static (single portion) of sheet of CNTs 146 is thus exposed to heat 15. After certain time, which depends on the original thickness of the sheet of CNTs 146, the sheet of CNTs is dried. The heating source 12 may be implemented in different ways. In embodiments of the invention, an infrared (IR) irradiation source is used. In embodiments of the invention, a convection source or hot air source is used. Other radiation sources, such as a ultra-violet (UV) irradiation source or an electrical resistance (ER) radiation source, may be used instead. The thickness of the resulting dry sheet of CNTs has been increased.

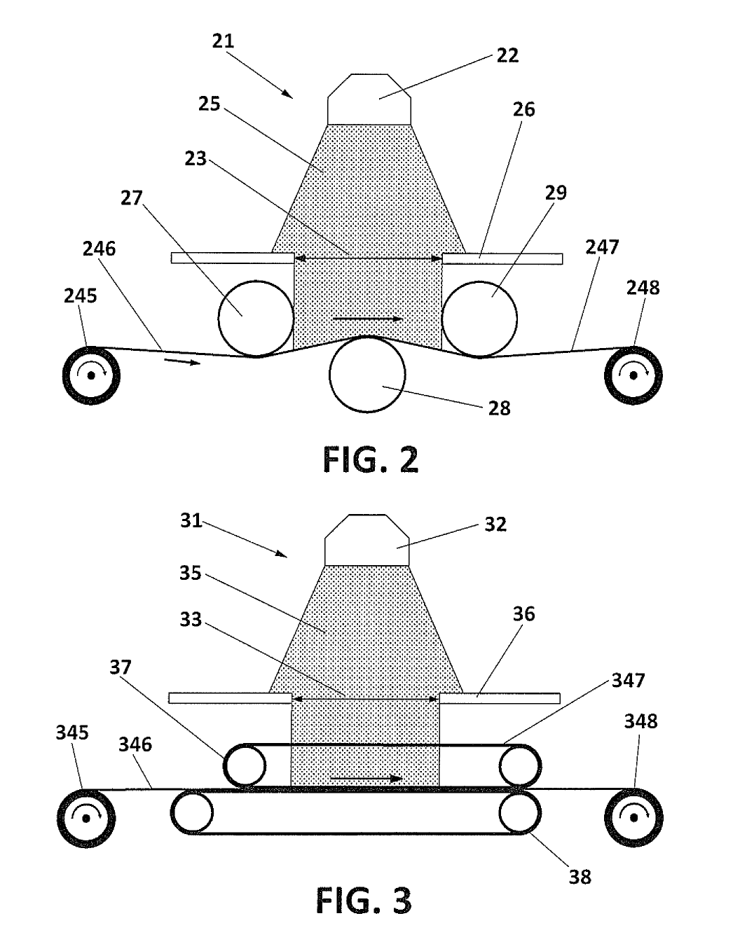

FIG. 1B shows a schematic representation of a second system for carrying out the method of the invention. This system is similar to the one in FIG. 1A. However, the system in FIG. 1B is suitable for increasing the thickness of a continuous sheet of CNTs. The continuous sheet of CNTs, wet and already separated from the filter used to manufacture the sheet of CNTs, may be provided in rolls 145. A drying unit 11 is shown. The wet continuous sheet of CNTs, forming a roll 145, is moved forward while it is unrolled 147 towards the drying unit 11. The sheet of CNTs may be moved automatically, for example actioned by driving means (for example actioning the roll 148 at the outside of the drying unit 11). The continuous sheet of CNTs 147 may be moved continuously, at low speed, or may be moved portion by portion, in an intermittent way, that is to say, it may be moved until a first portion of sheet of CNTs is disposed within the working area of the drying area 13 and then stopped for a time sufficient to dry that first portion. And then the sheet of CNTs is moved forward until a second portion thereof is disposed within the working area of the drying area 13, and so on. In any case, the continuous sheet of CNTs 147 is heated while the continuous sheet of CNT is progressively moved, either continuously or intermittently, in its longitudinal direction. The heat 15 is applied locally, that is to say, only under or within the operation of the drying area 13. The driving means of the continuous sheet of CNTs 147 is preferably disposed outside the drying unit 11. The drying unit 11 has a heat source 12 configured to provide heat 15 to a drying area 13. The heat source 12 may be movable. The drying area 13 is delimited by screening means 16, configured to delimit the drying area 13, preventing the heat 15 from passing through the screening means 16, and to delimit the drying time, in particular in the event of continuous movement of the sheet of CNTs. The screening means 16 may be implemented by means of two fixed screens or two movable screens. The screening means 16 may be of any material capable of blocking the heat emitted by the heat source, and of supporting the working temperature. In some embodiments, the screens may be made of metal plates that can be fixed in different positions depending on the desired drying area. Thus, only a portion of continuous sheet of CNTs 147 (that is to say, the portion passing under the drying area 13) is exposed to heat 15. Since the continuous sheet of CNTs 147 moves longitudinally, either continuously or at intervals (discontinuously), it is exposed to heat 15 only when it passes under the drying area 13. At the output of the drying unit 11, the already dried continuous sheet of CNTs 149 may be continuously rolled, forming a roll 148. In other words, the dried continuous sheet of CNTs 149 is rolled while it leaves the drying unit 11. Due to the two rolls 145, 148 of sheets of CNTs, respectively disposed at the input and output of the drying unit 11, this configuration is referred to as a direct roll-to-roll configuration. The heating source 12 may be implemented in the same possible ways as described in relation to FIG. 1A. After application of this continuous process, the thickness of the resulting dry sheet of CNTs 149 has been increased. However, certain deformation in the sheet of CNTs may be produced, in particular at the longitudinal sides, due to uneven drying, contraction forces or any other possible source of deformation. This potential deformation is solved as proposed in the implementations of FIGS. 2 and 3.

FIGS. 2 and 3 show different systems for carrying out the method of the invention, in which irregular deformation of the sheet of CNTs, which may occur in the drying process, is prevented by using means for preventing deformation.

FIG. 2 shows a schematic representation of a third system for carrying out the method of the invention. Like the system in FIG. 1B, the system in FIG. 2 is suitable for increasing the thickness of a continuous sheet of CNTs. It additionally avoids undesired bending of the longitudinal edges of the sheet of CNTs. A drying unit 21 is shown. The wet continuous sheet of CNTs, that may be forming a roll 245, is advanced while it is unrolled 246 towards the drying unit 21. The sheet of CNTs 246 may be moved automatically. The drying unit 21 has a heat source 22 configured to provide heat 25 to a drying area 23. The drying area 23 is delimited by screening means 26, having the same purpose and implementation as the screening means 16 in the second system. Like in the second system (FIG. 1B), there is a first roll 245 of wet continuous sheet of CNTs at the input of the drying unit 21 and a second roll 248 of dried continuous sheet of CNTs at the output of the drying unit 21. In this embodiment, a plurality of rollers 27, 28, 29 guide the continuous sheet of CNTs 246. In FIG. 2, three rollers are shown. The rollers roll freely, without being actioned. They contribute to avoid deformations in the continuous sheet of CNTs 246. The first and third rollers 27, 29 are preferably disposed respectively at the input and output of the drying area 23. For example, they may be disposed beneath the screening means 26. While the continuous sheet of CNTs is unrolled 246, it is obliged to move under the first roller 27, forming a concave shape. Then, for example when it is exposed to heat 25 in the drying area 23, the continuous sheet of CNTs is obliged to move above the second roller 28 (central roller), forming a convex shape. Next, at the output of the drying area 23, the continuous sheet of CNTs is obliged to move under the third roller 29, following the path it defines, forming a concave shape. One skilled in the art will understand that other configurations of rollers are possible. For example, the first and third rollers 27, 28 may be disposed beneath the sheet of CNTs, in such a way that the continuous sheet of CNTs is obliged to move above the first roller 27, forming a convex shape, then under the second roller 28 (disposed in this case above the sheet of CNTs), forming a concave shape, and finally above the third roller 29, forming again a convex shape. The three rollers 27-29 may be of the same shape and diameter. Alternatively, the central roller 28 may have a larger diameter. After being guided by the last roller 29, the already dried continuous sheet of CNTs 247 may be continuously rolled, forming a roll 248. Because the plurality of rollers 27-29 are disposed to force the sheet of CNTs to adopt alternatively concave and convex shapes, the rollers 27-29 are referred to as straightening rolls, since they prevent deformation in the continuous sheet of CNTs. In embodiments of the invention, the rollers 27-29 force the continuous sheet of CNTs 246 advancing in its longitudinal direction, to depart from the horizontal plane several degrees. For example, the sheet of CNTs may form an angle up to 20° (degrees) with respect to the horizontal plane when it passes above/below the corresponding rollers 27-29. The angle may be for example up to 15°, or up to 12°, or up to 10°. Like in the previous systems, the heating source 22 may be implemented in different ways. In embodiments of the invention, an infrared (IR) irradiation source is used. In embodiments of the invention, a convection source or hot air source is used. Other radiation sources, such as a ultra-violet (UV) irradiation source or an electrical resistance (ER) radiation source, may be used instead. After application of this continuous process, the thickness of the resulting dry sheet of CNTs 247 has been increased. Besides, thanks to the rollers 27-29, deformation in the sheet of CNTs, such as deformation in its longitudinal edges, has been prevented.

FIG. 3 shows a schematic representation of a fourth system for carrying out the method of the invention. Like the system in FIGS. 1B and 2, the system in FIG. 3 is suitable for increasing the thickness of a continuous sheet of CNTs. It additionally avoids undesired bending of the longitudinal edges of the sheet of CNTs. A drying unit 31, similar to drying units 11 21, is shown. The wet continuous sheet of CNTs, for example forming a roll 345, is advanced while it is unrolled 346 towards the drying unit 31. Like in the second and third systems, the sheet of CNTs may be moved automatically by means of driving means preferably located outside the drying unit 31 (for example actioning the second roll 348). Like in the first, second and third systems, the drying unit 31 has a heat source 32 configured to provide heat 35 to a drying area 33. A similar screening means 36 to the one used in the second and third systems, is used in this drying unit 31. Like in the second and third systems, there is a first roll 345 of wet continuous sheet of CNTs at the input of the drying unit 31 and a second roll 348 of dried continuous sheet of CNTs at the output of the drying unit 31. However, in this embodiment, the unrolled continuous sheet of CNTs 346, 347 is supported or guided by two support materials in order to prevent deformation of the sheet of CNTs, such as deformations in its longitudinal edges. The support materials may be implemented as conveyor belts 37, 38. A first conveyor belt 37 is disposed above the continuous sheet of CNTs 346, 347, longitudinally thereto, and very closed to its upper surface, preventing the sheet of CNTs from deforming upwards. A second conveyor belt 38 is disposed below the continuous sheet of CNTs 346, 347, longitudinally thereto, and very closed to its lower surface, therefore parallel to the first conveyor belt 37, preventing the sheet of CNTs from deforming downwards. In other words, the conveyor belts 37, 38 slightly press the sheet of CNTs in opposing directions, in order to maintain it straight (unwrinkled). The conveyor belts 37, 38 may be made of a porous material or may comprise a grillage, in order to favour the entrance of heat and also to favour liquid evaporation, therefore reducing the drying time. After being guided by the at least one conveyor belt, the already dried continuous sheet of CNTs 347 may be continuously rolled, forming a roll 348. Like in the previous systems, the heating source 32 may be implemented in different ways.

In embodiments of the invention, an infrared (IR) irradiation source is used. In embodiments of the invention, a convection source or hot air source is used. Other radiation sources, such as a ultra-violet (UV) irradiation source or an electrical resistance (ER) radiation source, may be used instead. The thickness of the resulting dry sheet of CNTs has been increased.

In the embodiments represented in FIGS. 1A, 1B, 2 and 3, an increase in the thickness of the dried sheet of CNTs 146, 149, 247, 347, is observed, with respect to the thickness of the similar sheets of CNTs dried without removing the filtering element. Or, if dried sheets of CNTs are used as input to the method of the invention, then soaked in an aqueous solution in order to apply the method of the invention, the increase in thickness can be clearly appreciated.

Next, some experiments that have been carried out are described.

In a first experiment, a first portion of sheet of CNTs produced by means of a conventional method for manufacturing sheets of CNTs (using a dispersion of multi-wailed CNTs in a liquid medium, with random orientation, followed by filtration through a filtering membrane with the aid of vacuum) has been subjected to a conventional drying stage, that is to say, it has been dried without separating the sheet of CNTs from the filter support (or support, in general), with which the sheet of CNTs is washed. The dimensions of the portion of sheet of CNTs are approximately 70 mm (70 millimeters=0.07 m) (length)×46 mm (width). It has been dried with an infrared (IR) source of radiation (power of 1100 W, distance of 45 cm between the CNT sheet and the infrared lamp). A second portion of sheet of CNTs is produced by means of exactly the same manufacturing method. It has the same dimensions as the first one. In fact, in some experiments the same BP has been cut in two portions (or more) that have been dried differently to have comparable results. However, instead of drying the sheet of CNTs without separating the sheet of CNTs from the filter support with which the sheet of CNTs was washed, both elements were separated and the method of the invention was applied. In particular, a system similar to the one shown in FIG. 3 has been used. The heat source was the same infrared radiation source. No screen was required (because no continuous sheet of CNTs was being dried). In order to prevent deformation, the portion of sheet of CNTs was disposed on a flat porous surface of a metallic mesh (acting as the lower conveyor belt 38 in FIG. 3) and a porous sheet of a metallic mesh (acting as the upper conveyor belt 37 in FIG. 3) was disposed on the upper surface of the sheet of CNTs. After drying, the thickness of the first sample (dried according to a conventional method, without separating the sheet of CNTs from the filter element) was 66 μm (microns, 10⁻⁶ m). In contrast, the thickness of the second sample (dried according to the method of the present invention), was 75 μm.

Therefore, an increase of 13% was obtained. This experiment proves the capacity of the method of the invention to increase the thickness of the resulting sheet of CNTs. It is remarked that this comparison has been established, instead of comparing the same wet portion of sheet of CNTs before and after applying the method of the invention, because it is extremely complicated to correctly measure the thickness of a wet sheet of CNTs. Besides, the purpose of the method is to increase its thickness with respect to sheets of CNTs manufactured by means of conventional methods, in which the stage of drying is performed without separating the sheet of CNTs from the filter element.

In a second experiment, it has been proved that the thickness is increased for a wide range of thickness. First, three portions of sheet of CNTs were produced by means of a conventional method for manufacturing sheets of CNTs, but with different filtering times in order to obtain sheets of CNTs with different thickness. The three of them were subjected to a conventional drying stage, that is to say, they were dried without separating the sheet of CNTs from the filter support (or support, in general), with which each sheet of CNTs was washed. The dimensions of the portions of sheets of CNTs were approximately 45 mm (length)×45 mm (width). They were dried with an infrared (IR) source of radiation (power of 1100 W, distance of 45 cm between the CNT sheet and the infrared lamp). Next, three additional portions of sheet of CNTs were produced by means of exactly the same manufacturing method. They had the same dimensions as the first three ones. However, instead of drying the sheets of CNTs without separating the sheet of CNTs from the filter support with which each sheet of CNTs was washed, in the three cases both elements were separated and the method of the invention was applied. In particular, a system similar to the one described for the first experiment was used. The following table summarizes the results:

| | Resulting | | |
|---|---|---|---|
| | thickness (μm) - | Resulting | |
| | dried with | thickness (μm) - | |
| | conventional | dried with method | Increase in |
| | method | of the invention | thickness (%) |
| 1^{st} sample | 44.5 | 50.4 | 13 |
| 2^{nd} sample | 61.5 | 69.4 | 13 |
| 3^{rd} sample | 76.6 | 85.1 | 11 |

As can be observed, in all the cases an increase of at least 11% was achieved. In particular, in two cases it was of 13%. This experiment proves the capacity of the method of the invention to increase the thickness of the resulting sheet of CNTs for sheets of CNTs of different thickness.

In a third experiment, it has been proved that the thickness is increased for a wide range of thickness also when the heating source is an air heater instead of an infrared source of radiation. First, three portions of sheet of CNTs were produced by means of a conventional method for manufacturing sheets of CNTs, but with different filtering times in order to obtain sheets of CNTs with different thickness. The three of them were subjected to a conventional drying stage, in this case with an air heater (2 h at 105° C.). In other words, they were dried without separating the sheet of CNTs from the filter support (or support, in general), with which each sheet of CNTs was washed. The sheets of CNTs had similar dimensions as in the previous experiments. Next, three additional portions of sheet of CNTs were produced by means of exactly the same manufacturing method. They had the same dimensions as the first three ones. However, instead of drying the sheets of CNTs without separating the sheet of CNTs from the filter support with which each sheet of CNTs was washed, in the three cases both elements were separated and the method of the invention was applied. In particular, a system similar to the one described for the first and second experiments, was used. The following table summarizes the results:

| | Resulting | | |
|---|---|---|---|
| | thickness (μm) - | Resulting | |
| | dried with | thickness (μm) - | |
| | conventional | dried with method | Increase in |
| | method | of the invention | thickness (%) |
| 1^{st} sample | 42.0 | 44.7 | 6 |
| 2^{nd} sample | 60.3 | 64.2 | 6 |
| 3^{rd} sample | 69.9 | 75.8 | 8 |

As can be observed, if an air heater is used instead of an infrared source of radiation, an increase in the thickness of the resulting sheet of CNTs is also achieved. However, the increase is larger when an infrared source of radiation is used.

Although the former experiments refer to “static” or batch portions of sheets of CNTs, that is to say, portions of sheets of CNTs of width and length of the same order of magnitude, these experiments have also been performed in a dynamic configuration (with continuous sheets of CNTs, for example provided in rolls). In all the cases, an increase in the thickness of the resulting sheets of CNTs, similar to the ones shown in experiments 1-3, has been observed.

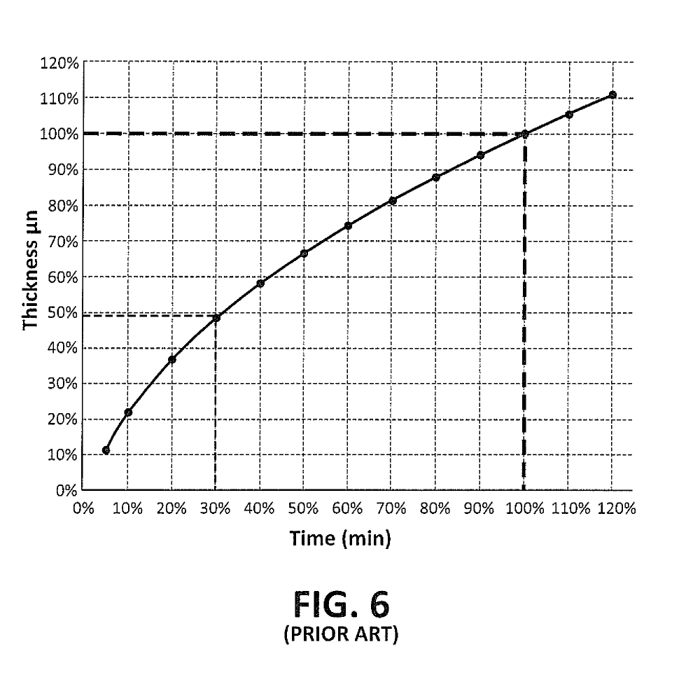

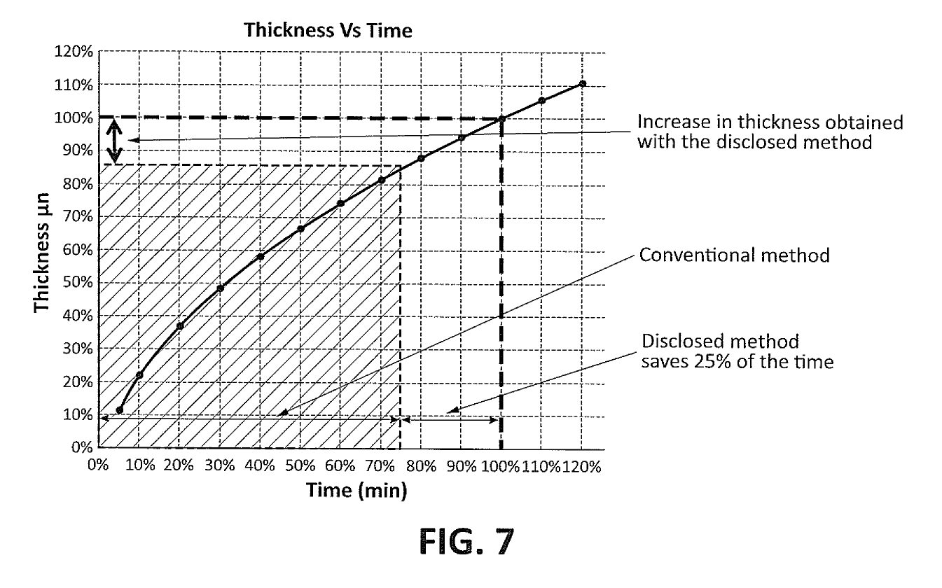

In sum, the method of the invention permits to save production time, thus increasing efficiency, thanks to the obtained increase in the thickness of the sheet of CNTs. For example, the graph represented in FIG. 6 shows the thickness vs time curve corresponding to a conventional process for manufacturing a sheet of CNTs. The behavior of this curve is not linear: in 30% of the nominal time, 50% of the thickness is generated. The filtration time is defined by the line speed. The production capacity (sqm) is also dependent on the line speed: higher line speeds lead to higher BP production (sqm) of lower thickness, while lower line speeds lead to lower BP production (sqm) of higher thickness. As shown in FIG. 7, because the method of the invention permits to obtain an increase in thickness of about 13%, the approximately last 22% of time required for achieving certain thickness using a conventional manufacturing method is saved.

In this text, the term “comprises” and its derivations (such as “comprising”, etc.) should not be understood in an excluding sense, that is, these terms should not be interpreted as excluding the possibility that what is described and defined may include further elements, steps, etc.

The invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. A method for increasing the thickness of a sheet of carbon nanotubes (CNTs), comprising:
providing a wet sheet of CNTs, wherein the sheet of CNTs is either a continuous sheet of CNTs or a portion of sheet of CNTs, wherein the wet sheet of CNTs is the result of applying a process for manufacturing a sheet of CNTs,
separating the wet sheet of CNTs from any filter or support element,
drying the wet sheet of CNTs by applying heat from a heat source.

2. The method of claim 1, wherein the wet sheet of CNTs being the result of applying a process for manufacturing a sheet of CNTs, is obtained by soaking in a liquid medium a dry sheet of CNTs already manufactured.

3. The method of claim 1, wherein the sheet of CNTs is continuous or a single portion thereof.

4. The method of claim 1, wherein the drying stage implies a continuous advancing of the sheet of CNTs, or an intermittent advancing thereof, or is static.

5. The method of claim 1, wherein the sheet of CNTs is a continuous sheet of CNTs and the drying of the wet continuous sheet of CNTs is done as follows:
moving forward the wet continuous sheet of CNTs in a longitudinal direction until a portion thereof is disposed within a drying unit comprising the heat source, the heat source being configured to provide heat to a drying area, the drying unit further comprising screening means for delimiting said drying area, in such a way that the portion of continuous sheet of CNTs is subject to heat only until while it is under the drying area.

6. The method of claim 5, wherein the drying unit further comprises a plurality of rollers configured to rotate freely and to guide the continuous sheet of CNTs along its longitudinal direction, forcing the continuous sheet of CNTs to adopt soft convex and concave curvatures in an alternate way.

7. The method of claim 6, wherein said plurality of rollers comprises a central roller disposed under the drying area and lateral rollers disposed under the screening means.

8. The method of claim 5, wherein the drying unit further comprises two conveyor belts configured to guide the continuous sheet of CNTs in its longitudinal direction, the conveyor belts being longitudinally disposed above and below the continuous sheet of CNTs, respectively.

9. The method of claim 8, wherein at least one conveyor belt is made of a porous material or comprises a grillage, in order to favour the entrance of heat and also to favour liquid evaporation, therefore reducing the drying time.

10. The method of claim 1, wherein the heating source is an infrared irradiation source or a convection source or hot air source, or an ultra-violet (UV) irradiation source or an electrical resistance (ER) radiation source, or a conduction source.

11. A method for manufacturing a continuous sheet of CNTs, comprising:
in a container filled with a liquid solution comprising CNTs at certain concentration, submerging a vacuum tank having a lower surface forming a grillage,
moving an elongated filtering membrane along the lower surface of the vacuum tank while vacuum is applied on the elongated filtering membrane in such a way that in the surface of the filtering membrane opposed to the surface in contact with the lower surface of the vacuum tank CNTs are deposited forming a continuous sheet of CNTs of constant thickness,
taking the filtering membrane together with the continuous sheet of CNTs out of the container,
separating the continuous sheet of CNTs from the filtering membrane or the support element, and
drying the continuous sheet of CNTs by applying the method of claim 1.

12. The method of claim 11, wherein prior to separating the continuous sheet of CNTs from the filtering membrane or the support element, the method comprises:
washing the continuous sheet of CNTs disposed on the filtering membrane or on a support element in a second container filled with cleaning solution,
taking the continuous sheet of CNTs together with the filtering membrane or the support element out of the second container.

13. A system for implementing the method of claim 1, the system comprising a drying unit comprising a heat source configured to provide heat to a drying area, the drying area being configured to receive the sheet of CNTs.

14. The system of claim 13, wherein the sheet of CNTs is continuous, the drying area being configured to receive the wet continuous sheet of CNTs as it moves forward in its longitudinal direction, the drying unit further comprising screening means for delimiting said drying area, in such a way that the portion of continuous sheet of CNTs is subject to heat only until while it is under the drying area.

15. The system of claim 13, wherein the drying area further comprises means for preventing deformation of the continuous sheet of CNTs during the drying stage, said means being either a plurality of rollers configured to rotate freely and to guide the continuous sheet of CNTs along its longitudinal direction, forcing the continuous sheet of CNTs to adopt soft convex and concave curvatures in an alternate way, or two conveyor belts configured to guide the continuous sheet of CNTs in its longitudinal direction.
